(19) United States
(12) Patent Application Publication
(10) Pub. No.: US 2025/0361373 A1
(43) Pub. Date: Nov. 27, 2025

(54) FOAM STABILIZERS FOR PHENOLIC FOAM

(71) Applicant: Evonik Operations GmbH, Essen (DE)

(72) Inventors: Sarah Otto, Essen (DE); Michael Suchan, Gelsenkirchen (DE); Martin Janßen, Muelheim an der Ruhr (DE)

(73) Assignee: Evonik Operations GmbH, Essen (DE)

(21) Appl. No.: 19/216,922

(22) Filed: May 23, 2025

(30) Foreign Application Priority Data
May 24, 2024 (EP) 24177903.2

(51) Int. Cl. C08J 9/04; C08G 77/38

(52) U.S. Cl. CPC C08J 9/04; C08G 77/38

(57) ABSTRACT

A composition for producing phenolic foam has at least one phenolic resin, at least one blowing agent, at least one catalyst, and at least one polyethersiloxane. A process produces a phenolic foam with a density of from 5 to 500 kg/m3 with a reaction mixture having the composition.

### CROSS-REFERENCE TO RELATED APPLICATIONS

This application is a new U.S. Patent Application which claims priority to European Patent Application No. 24177903.2, filed on May 24, 2024, the content of which is hereby incorporated by reference in its entirety.

### BACKGROUND OF THE INVENTION

### Field of the Invention

The present invention is in the field of phenolic foams. In particular, it relates to a composition for producing phenolic foam, to a process for producing phenolic foam, to a phenolic foam produced according to the invention, and to the use of polyethersiloxanes for improving the insulation capacity of phenolic foams. Phenolic foam is in the context of the present invention understood as meaning in particular a foam obtainable by reacting a phenolic resin with an acid as catalyst alongside addition of a blowing agent and a foam stabilizer.

Description of Related Art

Phenolic foams are known per se to those skilled in the art and are described for example in EP 3830174 A1, DE 602004006376 T2, EP 2898005 A1, EP 1922357 A1, WO 2022043561 A1, EP 4073155 A1, AU 2021238847 A1 or WO 2006114777 A1. Phenolic foams can also be referred to as phenolic resin foams or phenol foams. These terms are treated synonymously. This also applies to this invention.

In phenolic foam production, it is generally possible to use cell-stabilizing or foam-stabilizing additives that ensure a fine-celled, homogeneous foam structure with a low level of defects and hence exert an essentially positive influence on performance characteristics, especially the thermal insulation capacity, for example, of the foam. It is usually possible for this purpose to use foam stabilizers, for example foam stabilizers based on ethoxylated vegetable oils such as castor oil, as described for example in EP 3830174 A1. A particularly effective means of further improving the performance characteristics has been found to be the use of polyether-modified siloxanes, also referred to as polyethersiloxanes (PES), as described for example in WO 2022043561 A1, U.S. Pat. No. 3,298,973 A, GB 1088056 A, GB 1087056 A, DE 2833002 A1, U.S. Pat. No. 4,067,829 A, DE 2254305 A1 or WO 2009/048717 A1. The combination in particular of ethoxylated vegetable oils and polyether-modified siloxanes results in good performance characteristics. This combination therefore constitutes a type of foam stabilizer that is normally preferred in the production of phenolic foam.

U.S. Pat. No. 4,067,829 A, GB 1087056, GB 1088056, U.S. Pat. No. 3,298,973 A, DE 2254305 A1, WO 2009048717 A1 and DE 2833002 A1 describe the general use of polyether-modified siloxanes in phenolic foams for foam stabilization.

WO 2004/056911 A2 describes the general use of polyether-modified siloxanes as foam stabilizers for the production of closed-cell phenolic foams, these having a polysiloxane content of 25% to 35% by weight, a polyethylene oxide content of 50% to 55% by weight and a polypropylene oxide content of 15% to 20% by weight.

WO 2022/043561 A1 describes the use of polyether-modified siloxanes in combination with ethoxylated castor oil for the production of closed-cell phenolic foams, these having a polyethylene oxide content of <50% by weight. Preference is given therein to using polyether-modified siloxanes having a molar mass of 9500 to 25 000 g/mol.

The mentioned prior art documents contain no teaching on the extent to which the foam properties, in particular the thermal conductivity and the ageing of the thermal conductivity, can be improved by forming the structure of the polyether-modified siloxanes in a selective manner, for example through the choice of chain length or degree of modification of the polysiloxane or through the composition of the polyether residues.

### SUMMARY OF THE INVENTION

Against this background, the object of the present invention was to make it possible to provide phenolic foams having better performance characteristics, in particular better thermal conductivity, than the phenolic foams produced with conventional foam stabilizers.

### DETAILED DESCRIPTION OF THE INVENTION

The object is achieved by the subject matter of the invention. The invention provides a composition for producing phenolic foam, comprising at least one phenolic resin, at least one blowing agent, at least one catalyst and at least one polyethersiloxane of formula 1,

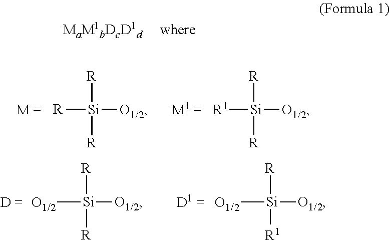

a=0 to 2,
b=0 to 2,
c=1 to 100, preferably 6 to 80, more preferably 6 to 60,
d=0 to 40, preferably 1 to 35, more preferably 1 to 30,
where

$$a + b = 2 ,$$

a+b+c+d=5 to 140, preferably 9 to 100, more preferably 14 to 50,
(a+b+c+d)/(b+d)=5 to 8.5, preferably 5 to 8.0, more preferably 5 to 7.5,
R=each independently identical or different alkyl radicals having 1 to 16 carbon atoms, identical or different aryl radicals having 6 to 16 carbon atoms, H or —O—R², preferably methyl, ethyl, phenyl or H, especially methyl,
R²=each independently identical or different alkyl radicals having 1 to 16 carbon atoms, identical or different aryl radicals having 6 to 16 carbon atoms or H,
R¹=each independently identical or different alkyl radicals having 6 to 18 carbon atoms or identical or different polyether radicals according to formula 2,

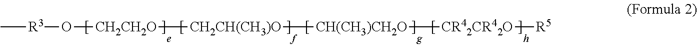

R³=each independently identical or different divalent alkyl radicals having 2 to 15 carbon atoms, preferably identical or different divalent alkyl radicals having 3 to 6 carbon atoms, especially preferably —(CH₂)₃—,
R⁴=each independently identical or different alkyl radicals having 1 to 18 carbon atoms that optionally include ether functions, or identical or different aryl radicals having 6 to 18 carbon atoms that optionally include ether functions, or H, preferably H, methyl, ethyl or phenyl,
   where the four radicals R⁴ in [CR⁴₂CR⁴₂O] are not all H,
   and where [CR⁴₂CR⁴₂O] does not comprise methyl as one radical R⁴ and H as the remaining three radicals R⁴,
R⁵=each independently identical or different radicals selected from the group consisting of: R² and C(O)R², preferably methyl, butyl, H or C(O)Me, more preferably H, methyl or C(O)Me,
e=0 to 100, preferably 0 to 80, especially 0 to 60,
f=0 to 100, preferably 0 to 80, especially 0 to 60,
g=0 to 100, preferably 0 to 80, especially 0 to 60,
h=0 to 100, preferably 0 to 60, more preferably 0,
where e+f+g+h=5 to 100, preferably 10 to 90, more preferably 10 to 80,
where not more than 50 mol % of the radicals R¹ in a polyethersiloxane of formula 1 are each independently identical or different alkyl radicals having 6 to 18 carbon atoms,
and where the at least one polyethersiloxane of formula 1 is present in a total amount of 0.1 to 20 parts by weight, preferably 0.5 to 10 parts by weight, more preferably 0.5 to 8 parts by weight, based on 100 parts by weight of the total phenolic resin used.

The subject matter of the invention is associated with a variety of benefits. For instance, it makes it possible to provide phenolic foams that meet known requirements. In particular, the phenolic foams have very good insulation properties and exhibit excellent long-term characteristics and high surface quality. This is advantageously made possible without adversely affecting the other properties of the material. Also made possible are particularly fine-celled, homogeneous foam structures with a low level of defects.

The subject matter of the invention makes it possible to provide phenolic foams having better performance characteristics, in particular better thermal conductivity, than the phenolic foams produced with conventional foam stabilizers.

The invention preferably also permits use alongside the Si-free surfactants known from the prior art, in particular the alkoxylated vegetable oils and the ethoxylated sorbitan fatty acid esters.

The composition according to the invention comprises at least one polyethersiloxane of formula 1. Polyethersiloxanes employable with preference for the purposes of the invention are described in the preferred embodiments of the invention that follow.

It is preferable that the at least one polyethersiloxane of formula 1 has the characteristic feature that less than 100 mol %, preferably less than 70 mol %, more preferably less than 50 mol %, of all radicals R¹ contain a polyether radical of the general formula 2 where f+g+h=0; particularly preferably, the at least one polyethersiloxane of formula 1 has the characteristic feature that no radical R¹ contains a polyether radical of the general formula 2 where f+g+h=0.

It is in addition preferable that the at least one polyethersiloxane of formula 1 has the characteristic feature that at least 25 mol %, preferably at least 50 mol %, more preferably at least 75 mol %, of all radicals R¹ contain a polyether radical of the general formula 2 where R⁵═H. Particularly preferably, 80 mol % to 100 mol % of all radicals R¹ contain a polyether radical of the general formula 2 where R⁵═H.

It is likewise preferable that the at least one polyethersiloxane of formula 1 has the characteristic feature that at least 30 mol %, preferably at least 40 mol %, more preferably at least 50 mol %, of all radicals R¹ contain a polyether radical of the general formula 2 where
e+f+g=17 to 60, preferably 19 to 40,
(f+g)/(e+f+g)>0 to 0.6, preferably 0.1 to 0.5, more preferably 0.15 to 0.4,
and
h=0.

Preferably, the at least one polyethersiloxane of formula 1 contains at least two different radicals R¹.

It is preferable that the at least one polyethersiloxane of formula 1 has the characteristic feature that it contains at least two different radicals R¹, where at least one radical R¹ is a polyether radical of formula 2 and one radical R¹ is an alkyl radical having 6 to 18 carbon atoms, where not more than 50 mol %, preferably not more than 25 mol %, of all radicals R¹ are alkyl radicals having 6 to 18 carbon atoms.

The composition according to the invention includes at least one blowing agent, preferably selected from the group consisting of
hydrocarbons having 3, 4 or 5 carbon atoms, preferably cyclo-, iso- and/or n-pentane and
halogenated hydrocarbons having 3, 4 or 5 carbon atoms, preferably isopropyl chloride, hydrofluoroolefins or hydrohaloolefins, preferably 1234ze, 1234yf, 1224 yd, 1233zd(E) and/or 1336mzz.

In addition, it is preferable that the composition according to the invention additionally comprises at least one silicon-free surfactant, preferably in a total amount of 0.1 to 15 parts by weight, preferably 1 to 10 parts by weight, based on 100 parts by weight of the total phenolic resin used, preferably selected from the group consisting of alkoxylated vegetable oil and ethoxylated sorbitan fatty acid ester.

Preferably, the alkoxylated vegetable oil is ethoxylated vegetable oil, preferably ethoxylated castor oil, and alkoxylated vegetable oil is preferably present in a total amount of 0.1 to 15 parts by weight, preferably 1 to 10 parts by weight, based on 100 parts by weight of the total phenolic resin used.

It is preferable that the alkoxylated vegetable oil contains 15 to 50 mol of alkylene oxide, preferably 20 to 45 mol of alkylene oxide, based on 1 mol of vegetable oil.

The ethoxylated sorbitan fatty acid ester is preferably polysorbate 20, polysorbate 40 and/or polysorbate 80, and the ethoxylated sorbitan fatty acid ester is preferably present in a total amount of 0.1 to 15 parts by weight, preferably 1 to 10 parts by weight, based on 100 parts by weight of the total phenolic resin used.

The composition according to the invention comprises at least one catalyst. It is preferable that the at least one catalyst is selected from the group consisting of organic and inorganic acids, the at least one catalyst preferably being selected from the group consisting of sulfuric acid, phosphoric acid, benzenesulfonic acid, xylenesulfonic acid, para-toluenesulfonic acid, ethylbenzenesulfonic acid, naphthalenesulfonic acid, cumenesulfonic acid and phenolsulfonic acid.

It is preferable that the at least one catalyst is present in a total amount of 1 to 30 parts by weight, preferably 1 to 25 parts by weight, more preferably 3 to 20 parts by weight, based on 100 parts by weight of the total phenolic resin used.

The composition according to the invention comprises at least one phenolic resin. The at least one phenolic resin preferably has a water content of 1% to 25% by weight, preferably 4% to 19% by weight, based on the total phenolic resin used.

A particularly preferred phenolic foam formulation in the context of this invention gives a foam density of 5 to 900 kg/m³ and has preferably the composition shown in Table 1, which corresponds to a preferred embodiment of the invention:

TABLE 1
Composition of a preferred phenolic foam formulation

| Component | Parts by weight |
|---|---|
| Phenolic resin | 80 to 120 |
| Blowing agent | >0 to 50 |
| Catalyst | 1 to 30 |
| Inventive polyethersiloxane of formula 1 | >0 to 15 |
| Optionally further additives (flame retardants, etc.) | 0 to 100 |

The present invention further provides a process for producing phenolic foam, carried out using a reaction mixture comprising a composition according to the invention as described above, in particular as defined in any of embodiments 1 to 14.

For further preferred embodiments and configurations of the process according to the invention, reference should also be made to the statements already given above in connection with the composition according to the invention.

The present invention further provides a phenolic foam produced by the aforementioned process of the invention, preferably using a composition according to the invention, in particular as defined in any of embodiments 1 to 14.

It is preferable that the phenolic foam has a density according to ASTM D1622-2020 of from 5 to 500 kg/m³, preferably 10 to 200 kg/m³, especially preferably from 12 to 100 kg/m³.

The invention further provides for the use of the phenolic foam of the invention for thermal insulation.

The invention further provides for the use of at least one polyethersiloxane of formula 1 in the production of phenolic foams, preferably using a composition of the invention, in particular as defined in any of embodiments 1 to 14.

The invention further provides for the use of at least one polyethersiloxane of formula 1 in the production of phenolic foams for improving the insulation capacity of phenolic foams, preferably phenolic foams according to embodiment 16, preferably produced using a composition according to any of embodiments 1 to 14.

Particularly preferred compositions according to the invention are described more particularly below.

A particularly preferred composition according to the invention comprises the following constituents:
at least one phenolic resin,
at least one blowing agent,
at least one catalyst,
at least one polyethersiloxane of formula 1
optionally further additives, etc.

The production of phenolic foams (these may also be referred to synonymously as phenolic resin foams) is known per se to those skilled in the art. For the production of phenolic foams, one or more phenolic resins are used, preferably one or more of the type known as resol resins. Correspondingly employable phenolic resins, preferably resol resins, are known per se. In particular, they can be produced in a known manner through condensation of phenol or a phenol-based compound, for example cresol, xylenol, para-alkyl phenol, para-phenylphenol, resorcinol or the like, and an aldehyde, for example formaldehyde, furfural, acetaldehyde or the like, under preferably basic conditions, for example by using a catalytic amount of alkali metal hydroxides, for example sodium hydroxide, potassium hydroxide or calcium hydroxide or an aliphatic amine, for example trimethylamine or triethylamine, preferably with an excess of aldehyde. This represents the usual way of producing phenolic resins, preferably resol resins, although the invention is not limited solely to the chemicals listed immediately above.

The molar ratio of phenol groups to aldehyde groups is not subject to any restriction. Preferably, the ratio is within a range from 1:1 to 1:3, more preferably within a range from 1:1.5 to 1:2.5. The phenolic resin preferably has, but is not limited to, a free aldehyde content of 0.1% by weight to 0.5% by weight. This can be determined by potentiometric titration according to ISO 11402:2004 with hydroxylamine hydrochloride. Preferred phenolic resins that can be used for foam production are liquids at 25° C. and standard pressure, preferably having water concentrations of from about 1% to 25% by weight, preferably 5% to 20% by weight, and preferably have methylol groups as reactive substituents, as described for example in EP 0170357 B1. If desired, the viscosity of the phenolic resin can be adjusted through inter alia the water content, for example. Thus, high water contents, for example, usually result in lower viscosity and can facilitate both the handling of the resin and its mixing during foam production.

Standard pressure is understood as meaning a pressure of 101 325 Pa.

The viscosity at 25° C. and standard pressure of phenolic resins employable with preference is preferably within a range from 1000 to 28 000 mPa*s and can be determined by the usual methods known to those skilled in the art, for example using a Brookfield viscometer. General information on the production and composition of phenolic resins can be found in the prior art and is described for example in EP 3830174 A1, EP 2898005 A1, WO 2022043561 A1 or EP 4073155 A1.

Blowing agents and the use thereof in the production of phenolic foams are known to those skilled in the art. The choice thereof may depend, for example, on the type of system and on the use of the phenolic foam obtained. Depending on the amount of blowing agent used, a foam having high or low density can for example be produced. For instance, it is possible to produce in accordance with ASTM D1622-20 foams having, for example, densities of preferably 5 kg/m³ to 900 kg/m³, preferably 5 to 500 kg/m³, more preferably 10 to 200 kg/m³, especially 12 to 100 kg/m³.

Blowing agents employable with particular preference have already been described above. Possible blowing agents used may be, for example, one or more of the appropriate compounds having suitable boiling points, for example hydrocarbons having 3, 4 or 5 carbon atoms, preferably cyclo-, iso- or n-pentane, halogenated hydrocarbons, for example chlorinated hydrocarbons such as dichloroethane, 1,2-dichloroethene, n-propyl chloride, isopropyl chloride, butyl chloride, isobutyl chloride, pentyl chloride, isopentyl chloride, 1,1-dichloroethene, trichloroethene or chloroethene, or hydrofluorocarbons (HFCs), for example HFC 245fa, HFC 134a or HFC 365mfc, hydrofluoroolefins (HFOs) or hydrohaloolefins, preferably 1234ze, 1234yf, 1224yd, 1233zd(E) or 1336mzz or mixtures thereof.

Catalysts employable with particular preference have already been described above. Catalysts employable for the production of phenolic foams are known to those skilled in the art, for example including from the prior art, and are described for example in EP 0170 357 A1 or, for example, in DE 602004006376 T2. The customary organic and inorganic acids known from the prior art can be employed with preference for this purpose. Preferably, one or more acids may be used. The following are employable with particular preference: sulfuric acid, phosphoric acid, benzenesulfonic acid, xylenesulfonic acid, para-toluenesulfonic acid, ethylbenzenesulfonic acid, naphthalenesulfonic acid, cumenesulfonic acid and/or phenolsulfonic acid. Catalysts used may in particular be mixtures of two or more of these compounds. The preferred amount of catalysts employed for complete reaction may be influenced inter alia by the water content of the phenolic resin and/or—when the catalyst is present as an aqueous solution—also by the water content thereof. For example, a higher water content may necessitate a higher acid concentration.

Phenolic foam may be formed in a known manner, i.e. especially through reaction of a mixture comprising phenolic resin, blowing agent, foam stabilizer and catalyst. When a catalyst is added to a mixture of phenolic resin, blowing agent and foam stabilizer, an exothermic reaction occurs between the methylol groups and phenol, resulting in the formation of methylene bridges and crosslinking. The condensation is accompanied by the liberation of water. The exothermicity of the reaction and foam formation may be influenced for example by the nature and amount of the acid employed, the properties of the blowing agent and the structure of the foam stabilizer.

Foam stabilizers and the use thereof in the production of phenolic foams are generally known to those skilled in the art, as described above. According to the invention, at least one polyethersiloxane of formula 1 is used. The at least one polyethersiloxane of formula 1 functions as foam stabilizer. In addition, it is also possible to use additional foam stabilizers that assist foam production. These compounds are sufficiently well known from the prior art. For example, EP 3830174 A1 describes the use of ethoxylated castor oil.

Optional additives used may be one or more of the substances known from the prior art that can typically be used in the production of phenolic foams, for example viscosity reducers, plasticizers, hardeners, flame retardants, cell-refining additives, fillers, dyes, pigments and/or fragrances. Suitable optional additives are described for example in EP 3830174 A1, U.S. Pat. No. 4,444,912 A and EP 1922357 A1.

Optional solid fillers used may, for example, be metal hydroxides, such as aluminium hydroxide or magnesium hydroxide, metal carbonates, such as calcium carbonate, magnesium carbonate, barium carbonate or zinc carbonate, metal oxides, such as aluminium oxide or zinc oxide, or metal powders, such as zinc. The viscosity of the phenolic resin can optionally be reduced using monoethylene glycol or polyester polyols, for example. Optional hardeners may, for example, be compounds having amino groups, such as urea or dicyandiamide. Preferably urea can be used. These can be used, for example, for foaming as well as for the production of the phenolic resin.

The process according to the invention for producing phenolic foams can be performed by any of the known methods. These are known to those skilled in the art and are for example also described in the patent literature, including EP 3830174 A1, for example.

Unless the opposite is apparent from this description, it is possible to combine any preferred or particularly preferred embodiment of the invention with one or more of the other preferred or particularly preferred embodiments of the invention.

Where ranges, general formulas or classes of compounds are stated, these are intended to encompass not just the corresponding ranges or groups of compounds explicitly mentioned but also all subranges and subgroups of compounds that can be obtained by extracting individual values (ranges) or compounds. Where documents are cited in the context of the present description, the entire content thereof, particularly with regard to the subject matter that forms the context in which the document has been cited, is intended to form part of the disclosure content of the present invention. Where averages are stated, these are numerical averages unless otherwise stated. Where parameters that have been determined by measurement are stated, the measurements have been carried out at a temperature of 23° C. and preferably at a pressure of 101 325 Pa, unless otherwise stated.

The invention is described further hereinbelow with reference to examples without this limiting the invention in any way.

### EXAMPLES

The polyethersiloxanes were prepared as described below and subjected to performance testing.

The catalyst used for the hydrosilylation was a platinum(0) 1,3-divinyl-1,1,3,3-tetramethyldisiloxane complex solution in xylene (2% Pt by weight). The CAS number of the complex is 68478-92-2. The catalyst was purchased from Sigma-Aldrich and used as received.

The SiH-functional siloxanes used were prepared in analogous manner to the description in example 1 of patent application DE 10 2008 042 181.

The principle of the preparation of allyl polyethers is well known to those skilled in the art and is described by way of example in example 1 of patent application EP4314111A1. By analogy thereto, the starting alcohol used was allyl alcohol.

All reactions were carried out with the aid of Schlenk techniques using nitrogen as inert gas.

### Example 1: Preparation of PES 1

For the synthesis of the polyethersiloxane PES 1, 64 g of an SiH-functional siloxane of the formula Me₃SiO(SiMe₂O)₃₈(SiMeHO)₁₀SiMe₃ was mixed together with 36 g of a polyether of formula CH₂═CHCH₂O(CH₂CH₂O)₉(CH₂CH(CH₃)O)₁H, 106 g of a polyether of formula CH₂═CHCH₂O(CH₂CH₂O)₁₁(CH₂CH(CH₃)O)₁₀H and 94 g of a polyether of formula CH₂═CHCH₂O(CH₂CH₂O)₂₃(CH₂CH(CH₃)O)₄H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 2: Preparation of PES 2

For the synthesis of the polyethersiloxane PES 2, 84 g of an SiH-functional siloxane of the formula HMe₂SiO(SiMe₂O)₄₀(SiMeHO)₈SiMe₂H was mixed together with 38 g of a polyether of formula CH₂═CHCH₂O(CH₂CH₂O)₉(CH₂CH(CH₃)O)₁H and 178 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 3: Preparation of PES 3

For the synthesis of the polyethersiloxane PES 3, 58 g of an SiH-functional siloxane of the formula Me₃SiO(SiMe₂O)₁₄(SiMeHO)₄SiMe₃ was mixed together with 112 g of a polyether of formula CH₂═CHCH₂O(CH₂CH₂O)₂₃(CH₂CH(CH₃)O)₄H and 130 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 4: Preparation of PES 4

For the synthesis of the polyethersiloxane PES 4, 61 g of an SiH-functional siloxane of the formula Me₃SiO(SiMe₂O)₁₄(SiMeHO)₄SiMe₃ was mixed together with 101 g of a polyether of formula CH₂═CHCH₂O(CH₂CH₂O)₁₁(CH₂CH(CH₃)O)₁₀H and 138 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 5: Preparation of PES 5

For the synthesis of the polyethersiloxane PES 5, 51 g of an SiH-functional siloxane of the formula Me₃SiO(SiMe₂O)₃₈(SiMeHO)₁₀SiMe₃ was mixed together with 132 g of a polyether of formula CH₂═CHCH₂O(CH₂CH₂O)₂₂(CH₂CH(CH₃)O)₁₁H and 116 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 6: Preparation of PES 6

For the synthesis of the polyethersiloxane PES 6, 52 g of an SiH-functional siloxane of the formula Me₃SiO(SiMe₂O)₁₄(SiMeHO)₄SiMe₃ was mixed together with 132 g of a polyether of formula CH₂═CHCH₂O(CH₂CH₂O)₂₂(CH₂CH(CH₃)O)₁₁H and 116 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained. _{Example} 7: Preparation of PES 7

For the synthesis of the polyethersiloxane PES 7, 75 g of an SiH-functional siloxane of the formula HMe₂SiO(SiMe₂O)₅₅(SiMeHO)₈SiMe₂H was mixed together with 225 g of a polyether of formula CH₂═CHCH₂O(CH₂CH₂O)₂₃(CH₂CH(CH₃)O)₄H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 8: Preparation of PES 8

For the synthesis of the polyethersiloxane PES 8, 57 g of an SiH-functional siloxane of the formula Me₃SiO(SiMe₂O)₃₈(SiMeHO)₁₀SiMe₃ was mixed together with 113 g of a polyether of formula CH₂═CHCH₂O(CH₂CH₂O)₂₃(CH₂CH(CH₃)O)₄H and 130 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 9: Preparation of PES 9

For the synthesis of the polyethersiloxane PES 9, 66 g of an SiH-functional siloxane of the formula Me₃SiO(SiMe₂O)₁₂₃(SiMeHO)₂₅SiMe₃ was mixed together with 108 g of a polyether of formula CH₂═CHCH₂O(CH₂CH₂O)₂₃(CH₂CH(CH₃)O)₄H and 125 g of a polyether of formula CH₂═CHCH₂O(CH₂CH₂O)₁₂(CH₂CH(CH₃)O)₇H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 10: Preparation of PES 10

For the synthesis of the polyethersiloxane PES 10, 131 g of an SiH-functional siloxane of the formula HMe₂SiO(SiMe₂O)_{37,1}(SiMeHO)_{2,9}SiMe₂H was mixed together with 168 g of a polyether of formula CH₂═CHCH₂O(CH₂CH₂O)₁₂(CH₂CH(CH₃)O)—CH₃ in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 11: Preparation of PES 11

For the synthesis of the polyethersiloxane PES 11, 110 g of an SiH-functional siloxane of the formula Me₃SiO(SiMe₂O)₅₁(SiMeHO)₇SiMe₃ was mixed together with 190 g of a polyether of formula CH₂═CHCH₂O(CH₂CH₂O)₁₃(CH₂CH(CH₃)O)₃H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 12: Preparation of PES 12

For the synthesis of the polyethersiloxane PES 12, 148 g of an SiH-functional siloxane of the formula Me₃SiO(SiMe₂O)₆₅(SiMeHO)₈SiMe₃ was mixed together with 151 g of a polyether of formula CH₂═CHCH₂O(CH₂CH₂O)₁₀H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 13: Preparation of PES 13

For the synthesis of the polyethersiloxane PES 13, 126 g of an SiH-functional siloxane of the formula Me₃SiO(SiMe₂O)₁₀₈(SiMeHO)₁₀SiMe₃ was mixed together with 174 g of a polyether of formula CH₂═CHCH₂O(CH₂CH₂O)₅(CH₂CH(CH₃)O)₁₁H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 14: Preparation of PES 14

For the synthesis of the polyethersiloxane PES 14, 121 g of an SiH-functional siloxane of the formula Me₃SiO(SiMe₂O)₂₁(SiMeHO)₂SiMe₃ was mixed together with 89 g of a polyether of formula CH₂═CHCH₂O(CH₂CH₂O)₁₂(CH₂CH(CH₃)O)₇H and 89 g of a polyether of formula CH₂═CHCH₂O(CH₂CH₂O)₁₂(CH₂CH(CH₃)O)₇Me in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

### Example 15: Preparation of PES 15

For the synthesis of the polyethersiloxane PES 15, 89 g of an SiH-functional siloxane of the formula Me₃SiO(SiMe₂O)₂₈(SiMeHO)₁₀SiMe₃ was mixed together with 211 g of a polyether of formula CH₂═CHCH₂O(CH₂CH₂O)₁₀H in a 500 mL four-necked flask with precision glass stirrer, thermometer, reflux condenser and nitrogen inlet. The mixture was heated to 90° C. 0.15 g of a platinum(0) 1,3-divinyl-1,1,3,3-tetramethyldisiloxane complex solution in xylene was then added. An exothermic reaction set in. The reaction mixture was then stirred at 90° C. for two hours. After this time, the degree of conversion of the SiH groups was determined by gas volumetry. It was 100%. A clear product was obtained.

TABLE 2
Composition of the polyethersiloxanes (PES)

| | | | | Polyethylene | Polypropylene |
|---|---|---|---|---|---|
| | | M* | Polysiloxane | oxide | oxide |
| | | kg/ | content* | content* | content* |
| PES | Inventive | mol | % by wt. | % by wt. | % by wt. |
| PES 1 | yes | 13.4 | 26.8 | 46.1 | 24.0 |
| PES 2 | yes | 12.0 | 29.6 | 40.2 | 26.7 |
| PES 3 | yes | 5.9 | 24.3 | 49.2 | 23.6 |
| PES 4 | yes | 5.6 | 25.7 | 36.2 | 35.1 |
| PES 5 | yes | 16.4 | 21.9 | 43.6 | 32.0 |
| PES 6 | yes | 6.6 | 22.0 | 43.5 | 31.9 |
| PES 7 | yes | 17.7 | 26.5 | 58.3 | 12.8 |
| PES 8 | yes | 14.8 | 24.2 | 49.3 | 23.6 |
| PES 9 | no | 38.8 | 27.8 | 47.0 | 22.5 |
| PES 10 | no | 7.9 | 38.5 | 31.9 | 26.1 |
| PES 11 | no | 9.9 | 43.9 | 42.5 | 10.6 |
| PES 12 | no | 9.6 | 57.0 | 39.4 | 0 |
| PES 13 | no | 17.8 | 49.4 | 12.1 | 36.2 |
| PES 14 | no | 3.8 | 47.9 | 27.2 | 22.3 |
| PES 15 | no | 7.8 | 36.2 | 58.4 | 0 |

*The reported values correspond to the theoretically obtained values based on the composition of the SiH-siloxanes and polyethers.

### Production of the Phenolic Foam

For the performance comparison, the formulation shown in Table 3 was used. The comparative foaming operations were carried out by manual mixing. This was done by weighing the phenolic resin (amount per run: 180±5 g) and foam stabilizer into a beaker and mixing with a disc stirrer (diameter 6 cm) at 20° C. and 1000 rpm for 15 s. The blowing agent was then added and the mixture mixed at 1500 rpm for 30 s. The acid was then added and the mixture stirred at 2500 rpm for 30 s and transferred to a 25 cm×25 cm×7 cm aluminium mould lined with polyethylene film and thermostatically controlled at 60° C. After 30 min, the foams were demoulded and hardened in an oven heated to 60° C. for 42 h.

The open-cell content was determined using an AccuPyc Il series pycnometer in a 100 cm³ measuring chamber and with a 5×3×3 cm test specimen. Immediately after cooling to room temperature after hardening in the oven, the initial thermal conductivity coefficient (λ value in mW/m·K) was measured on 2.5 cm-thick discs using a LaserComp FOX200 instrument at an average temperature of 23° C. in accordance with the specifications of standard EN12667:2001. For determination of the ageing values, the test specimens were stored in the oven at 70° C. for 7 days and the thermal conductivity then determined again as described above.

TABLE 3
Formulation for production of phenolic foam

| Component | Parts by weight |
|---|---|
| Phenolic resin* | 100 |
| Foam stabilizer | 4.5 |
| Cyclopentane/isopentane 85/15** | 10 |
| Phenolsulfonic acid 65% by weight in water | 18 |

*Phenolic resin Cellobond ® J6014L from Bakelite
**Parts by weight of the cyclopentane/isopentane mixture

The polyethersiloxane foam stabilizers according to the invention were investigated both individually and in combination with Si-free surfactants. This was done using Tagat® CH 40 as ethoxylated castor oil from Evonik Operations GmbH and polysorbate 80. The results are presented in Table 4.

TABLE 4
Properties of the phenolic foams

| | Open-cell | λ (initial) | λ (ageing) |
|---|---|---|---|
| Foam stabilizer | content in % | in mW/mK | in mW/mK |
| PES 1 | 8 | 20.2 | 23.1 |
| Tagat ® CH 40/ | 7 | 19.7 | 23.9 |
| PES 1 (3.5:1.0) * | | | |
| Polysorbate 80/ | 7 | 20.2 | 23.9 |
| PES 1 (3.5:1.0) * | | | |
| PES 2 | 6 | 19.7 | 23.0 |
| PES 3 | 7 | 19.9 | 21.7 |
| Tagat ® CH 40/ | 6 | 19.6 | 22.8 |
| PES 3 (3.5:1.0) * | | | |
| Polysorbate 80/ | 8 | 20.5 | 23.4 |
| PES 3 (3.5:1.0) * | | | |
| PES 4 | 8 | 20.4 | 22.7 |
| PES 5 | 7 | 20.2 | 22.1 |
| PES 6 | 7 | 20.0 | 22.1 |
| PES 7 | 6 | 20.2 | 23.7 |
| Tagat ® CH 40/ | 8 | 19.4 | 23.2 |
| PES 7 (3.5:1.0) * | | | |
| Polysorbate 80/ | 6 | 19.9 | 23.6 |
| PES 7 (3.5:1.0) * | | | |
| PES 8 | 6 | 19.6 | 22.4 |
| Tagat ® CH 40/ | 6 | 19.7 | 22.9 |
| PES 8 (3.5:1.0) * | | | |
| Polysorbate 80/ | 6 | 20.0 | 23.2 |
| PES 8 (3.5:1.0) * | | | |
| PES 9 | 10 | 20.8 | 29.1 |
| PES 10 | 11 | 21.5 | 27.8 |
| PES 11 | 11 | 22.9 | 33.0 |
| PES 12 | 53 | 24.7 | 33.8 |
| PES 13 | collapse | collapse | collapse |
| PES 14 | 20 | 26.0 | 33.1 |
| PES 15 | 25 | 24.6 | 30.8 |

* Mixing ratios correspond to parts by weight.

The results show that it is possible with the foam stabilizers of the invention to achieve foam qualities and thermal conductivities that are higher than those of noninventive foam stabilizers. In particular, the A values after ageing, which are critical for use, show a marked improvement. All other use-relevant foam properties are affected only negligibly, if at all, by the foam stabilizers according to the invention.

1. A composition for producing phenolic foam, comprising:
at least one phenolic resin,
at least one blowing agent,
at least one catalyst, and
at least one polyethersiloxane of formula 1, 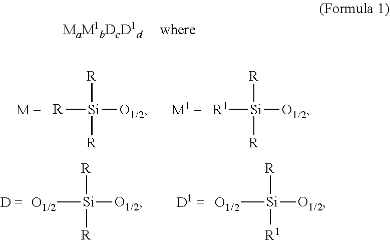
a=0 to 2,
b=0 to 2,
c=1 to 100,
d=0 to 40,
where
$$\begin{matrix}a + b = 2 , \\ a + b + c + d = 5 to 140 , \\ ( a + b + c + d ) / ( b + d ) = 5 to 8.5 ,\end{matrix}$$
R=each independently identical or different alkyl radicals having 1 to 16 carbon atoms, identical or different aryl radicals having 6 to 16 carbon atoms, H or —O—R²,
R²=each independently identical or different alkyl radicals having 1 to 16 carbon atoms, identical or different aryl radicals having 6 to 16 carbon atoms or H,
R¹=each independently identical or different alkyl radicals having 6 to 18 carbon atoms or identical or different polyether radicals according to formula 2, 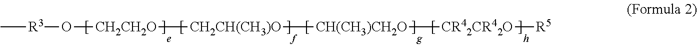
R³=each independently identical or different divalent alkyl radicals having 2 to 15 carbon atoms,
R⁴=each independently identical or different alkyl radicals having 1 to 18 carbon atoms that optionally include ether functions, or identical or different aryl radicals having 6 to 18 carbon atoms that optionally include ether functions, or H, where the four radicals R⁴ in [CR⁴₂CR⁴₂O] are not all H,
and where [CR⁴₂CR⁴₂O] does not comprise methyl as one radical R⁴ and H as the remaining three radicals R⁴,
R⁵=each independently identical or different radicals selected from the group consisting of R² and C(O)R²,
e=0 to 100,
f=0 to 100,
g=0 to 100,
h=0 to 100,
where e+f+g+h=5 to 100,
where not more than 50 mol % of the radicals R¹ in a polyethersiloxane of formula 1 are each independently identical or different alkyl radicals having 6 to 18 carbon atoms
and where the at least one polyethersiloxane of formula 1 is present in a total amount of 0.1 to 20 parts by weight, based on 100 parts by weight of the total phenolic resin used.

2. The composition according to claim 1, wherein the at least one polyethersiloxane of formula 1 has a characteristic feature that less than 100 mol % of all radicals R¹ contain a polyether radical of the general formula 2,
where
$$f + g + h = 0 .$$

3. The composition according to claim 1, wherein the at least one polyethersiloxane of formula 1 has a characteristic feature that at least 25 mol % of all radicals R¹ contain a polyether radical of the general formula 2,
where
R⁵═H.

4. The composition according to claim 1, wherein the at least one polyethersiloxane of formula 1 has a characteristic feature that at least 30 mol % of all radicals R¹ contain a polyether radical of the general formula 2,
where
$$\begin{matrix}e + f + g = 17 to 60 , \\ ( f + g ) / ( e + f + g ) > 0 to 0.6 , and \\ h = 0.\end{matrix}$$

5. The composition according to claim 1, wherein the at least one polyethersiloxane of formula 1 has a characteristic feature that it contains at least two different radicals R¹.

6. The composition according to claim 1, wherein the at least one polyethersiloxane of formula 1 has a characteristic feature that it contains at least two different radicals R¹,
where
at least one radical R¹ is a polyether radical of formula 2 and one radical R¹ is an alkyl radical having 6 to 18 carbon atoms, where not more than 50 mol % of all radicals R¹ are alkyl radicals having 6 to 18 carbon atoms.

7. The composition according to claim 1, wherein the at least one blowing agent is selected from the group consisting of hydrocarbons having 3, 4 or 5 carbon atoms
and halogenated hydrocarbons having 3, 4 or 5 carbon atoms.

8. The composition according to claim 1, wherein at least one silicon-free surfactant is additionally present.

9. The composition according to claim 8, wherein the at least one silicon-free surfactant is an ethoxylated vegetable oil.

10. The composition according to claim 8, wherein the at least one silicon-free surfactant contains 15 to 50 mol of alkylene oxide, based on 1 mol of the at least one silicon-free surfactant.

11. The composition according to claim 8, wherein the at least one silicon-free surfactant is polysorbate 20, polysorbate 40 and/or polysorbate 80.

12. The composition according to claim 1, wherein the at least one catalyst is selected from the group consisting of organic and inorganic acids.

13. The composition according to claim 1, wherein the at least one catalyst is present in a total amount of 1 to 30 parts by weight, based on 100 parts by weight of the total phenolic resin used.

14. The composition according to claim 1, wherein the at least one phenolic resin has a water content of 1% to 25% by weight, based on the total phenolic resin used.

15. A process for producing a phenolic foam, comprising:
carrying out the process with a reaction mixture comprising a composition as defined in claim 1.

16. A phenolic foam produced by the process according to claim 15, wherein the phenolic foam has a density according to ASTM D1622-20 of from 5 to 500 kg/m³.
